(19) United States
(12) Patent Application Publication
(10) Pub. No.: US 2016/0125456 A1
(43) Pub. Date: May 5, 2016

(54) ADVERTISING CAMPAIGN TARGETING USING CONTEXTUAL DATA

(71) Applicant: DS-IQ, Inc., Bellevue, WA (US)

(72) Inventors: Wan-Chung William Wu, Bellevue, WA (US); Thomas Opdycke, Bellevue, WA (US)

(21) Appl. No.: 14/531,909

(22) Filed: Nov. 3, 2014

(51) Int. Cl. G06Q 30/02

(52) U.S. Cl. CPC G06Q 30/0251

(57) ABSTRACT

Various embodiments use contextual data to improve the targeting of advertising campaigns to consumers. Contextual data may include, e.g., data pertaining to products purchased or sold, places associated with a purchase or sale, and persons involved in the purchase or sale transaction. The collected contextual data may have a temporal component and a location component. The collected contextual data also has a location component, meaning that the data is associated with a particular coordinate, address, region, or other location. Time and location information may be used to recognize that sales patterns vary based on various factors. Associating a timestamp and a location with each piece of contextual data allows the system in some embodiments to subsequently improve advertising campaign targeting using the timing and location data as described herein in some embodiments.

### BACKGROUND

Preparation and implementation of an advertisement campaign can be a difficult and daunting task. Much of the difficulty arises from the multitude of factors which can influence the campaign's success. For example, different consumer populations may react differently to different products and to various environmental factors. Various products and environmental factors may also depend upon one another in unusual and unexpected ways. Furthermore, the correlations may be subject to rare and aperiodic events (e.g., the Superbowl™ may generate sports-related purchasing behaviors in populations that may not otherwise be interested in sports-related products).

Even when correlations between populations and purchasing behaviors have been identified, implementing a campaign successfully still requires knowledge of the available resources and conditions at the various outlets providing the product. This may be especially important where the advertisement impressions are desired to result in immediate conversions. Thus, it would be desirable to integrate disparate information sources into a manner facilitating analysis for planning an advertisement campaign. Unfortunately, integrating information sources in such a manner is often an intractable task.

### BRIEF DESCRIPTION OF THE DRAWINGS

The techniques introduced here may be better understood by referring to the following Detailed Description in conjunction with the accompanying drawings, in which like reference numerals indicate identical or functionally similar elements:

FIG. 1A is a plot depicting a relationship between shopper relevancy and advertising campaign sophistication as can occur in some circumstances;

FIG. 1B is a series of Venn diagrams depicting advertising targeting using segmentation or personalization;

FIG. 1C is a plot of certain contextual data representing a hypothetical birth volume index over time;

FIG. 1D is a series of Venn diagrams depicting advertising targeting using contextual information to generate micro-segments;

FIG. 2 is a block diagram depicting the topology of an example use case as can occur in various of the disclosed embodiments;

FIGS. 3A and 3B are a block diagram depicting the data flow from various sources through a context processing system to generate an advertising campaign as can occur in some embodiments;

FIG. 4 is a flow diagram depicting an analysis and advertisement resource allocation process at a high level as can be implemented in various of the disclosed embodiments;

FIG. 5 is a block diagram depicting various “Product-Place-Person” data consolidations as can be implemented in some embodiments;

FIG. 6 is a block diagram depicting the data flow from various sources as can occur in some embodiments;

FIG. 7 is a three-dimensional plot of an example segmentation result as can occur in various of the disclosed embodiments;

FIG. 8 is a block diagram illustrating components in a targeting output as can occur in various of the disclosed embodiments;

FIG. 9 is a process diagram illustrating a cluster segmentation process in greater detail as can be implemented in some embodiments;

FIG. 10 is a table reflecting the results from an example cluster segmentation process as can be implemented in some embodiments;

FIG. 11 is a screenshot of a GUI for navigating a campaign relevance analysis as can be implemented in some embodiments;

FIG. 12 is a screenshot of a GUI for products in a campaign as can be implemented in some embodiments;

FIG. 13 is a screenshot of a GUI for adding contextual variables to a campaign construction analysis as can be implemented in some embodiments; and

FIG. 14 is a block diagram of a computer system as can be used to implement features of some of the embodiments.

### DETAILED DESCRIPTION

### General Description

A system and methods for applying contextual data to improve audience selection and targeting of advertising campaigns to consumers are disclosed herein. In some embodiments, the system collects and processes different categories of contextual data that are either directly associated with, or can be associated with, the purchase of, sale of, or engagement with products. Contextual data generally includes environmental factors related to a consumer-product relation. For example, contextual data can include, but is not limited to, data pertaining to products purchased or sold, places associated with a purchase or sale, and persons involved in the purchase or sale transaction. The system can also collect other contextual data surrounding the interaction of the consumer with the product, such as engagement information, impression and loyalty information, or other similar types of data.

In some embodiments, the collected contextual data includes a temporal component, wherein the data is associated with a particular time or a particular time period. The collected contextual data can also include a location component associating the data with a particular coordinate, address, region, or other location. The time and location information can be used to indirectly infer the effect of various contextual factors. For example, sales and engagement patterns can vary based on the day of the week, weather at a particular store can vary dramatically from day to day, the purchases and engagement made by an individual are associated with a particular date and time at which the purchase or engagement was made, etc.

Accordingly, in addition to capturing the underlying data (e.g., an identification of a purchased product), in some embodiments the system associates a timestamp with each piece of collected data. The system can also associate location information with each piece of collected data. Associating a timestamp and a location with the contextual data allows the system to subsequently improve the selection of the most relevant audience and therefore improve advertising campaign targeting as described herein.

In some circumstances, the timestamps and location information is already contained within the collected contextual data. For example, a record of the weather over the past month may include high and low temperatures associated with each day at a particular location. In some circumstances, the collected data may not expressly contain adequate time or location information. In those circumstances, the system can infer or impute timestamps or locations for the collected data. For purposes of comparison and use of dissimilar contextual data, the system can convert received timing information so that the timing information of all contextual data is based on a common time base. For example, timing data from different time zones can be normalized to a specified time zone, or to an arbitrary centralized format. The system also uses a common notation for the location, such as zip code, address, or GPS coordinates.

Based upon the associated timestamps, the system in some embodiments is able to ensure that the data remains relevant by constantly removing or discounting data as time passes. For example, historic data can be removed from the dataset after a time period has elapsed. The time periods can also vary depending on the type of contextual data. For example, certain contextual data may have a long lifespan and the system can use the data for several years. However, other contextual data may have a short lifespan and the system can discard or renew the data, e.g., every quarter. In addition to or in lieu of discarding older contextual data, the system can discount the effect of older data by applying a weighting factor to the data in some embodiments. For example, in targeting algorithms, data more than a year old can be weighted at 50% of the value of data that is less than a year old.

Once the dataset of contextual insights data has been constructed, the dataset is used for purposes of identifying audience segments to target for advertising campaigns. Segments are generated by the system based on time and location which allows targeting to identify the intended audience more precisely based upon campaign timing and location. As will be described in additional detail herein, when such segments are generated at a granular level based on time or location (e.g., hourly or daily by zip+4 code), the segments are referred to as “micro-segments” herein. Using geographic, demographic, or certain other advertising campaign criteria that is received from a user, the system identifies various audience micro-segments that would be more susceptible to the advertising campaign at the specified time and locations. These audience micro-segments can be associated with scores indicating the likelihood of individuals within the micro-segments purchasing a given product or service. Segments associated with scores exceeding a threshold may be added to the targeted audience. Audience micro-segments having scores that fall below the threshold may be excluded from the targeted audience. By building the targeted audience based on micro-segments, the system enables the user to target only those individuals that have demonstrated a propensity to purchase the advertised product at the time and location of the offering. Such improved targeting allows a campaign planner to more efficiently and more effectively deploy scarce advertisement resources.

In some embodiments, when the system receives criteria from a planner specifying the desired campaign exposure, the system interprets the criteria as a “preferred factor” but not necessarily a factor mandatory for performing the targeting. For example, a particular campaign factor specified by a user can be weighted more heavily when identifying an audience micro-segment, but will not necessarily be present in that micro-segment. Instead, the system seeks to balance the specified criteria with a desired outcome in order to select those micro-segments most likely to achieve the desired campaign goals.

Various examples of the disclosed techniques will now be described in further detail. The following description provides specific details for a thorough understanding and enabling description of these examples. One skilled in the relevant art will understand, however, that the techniques discussed herein can be practiced without many of these details. Likewise, one skilled in the relevant art will also understand that the techniques can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the embodiments. Indeed, certain terms may even be emphasized below; however, any terminology intended to be interpreted in any restricted manner will be overtly and specifically defined as such in this section.

### Motivational Overview

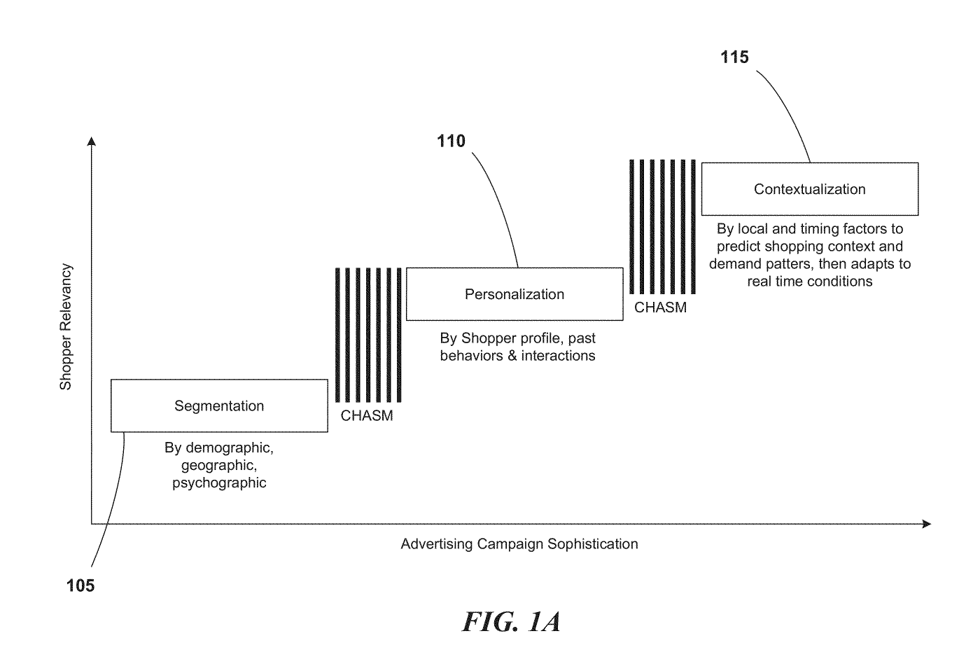

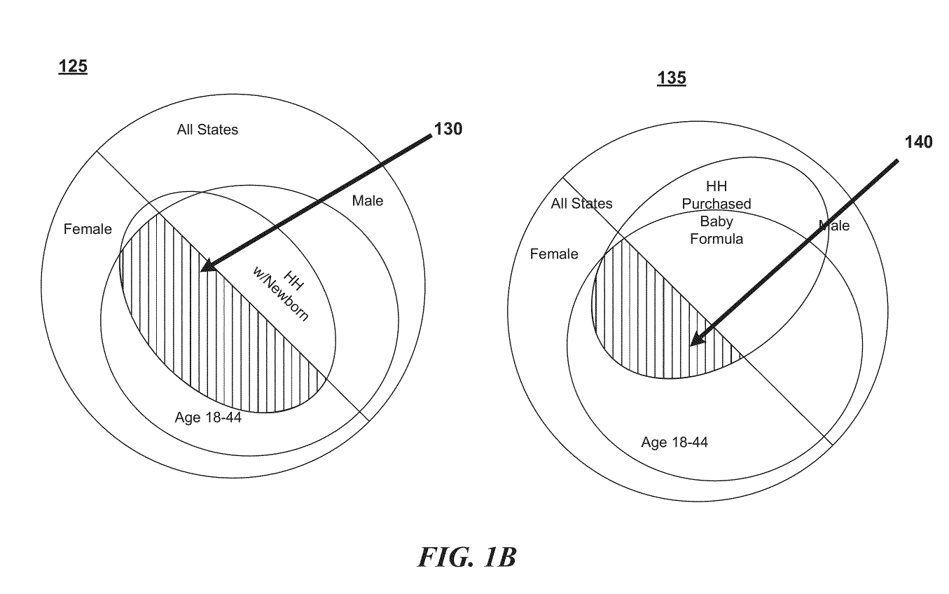

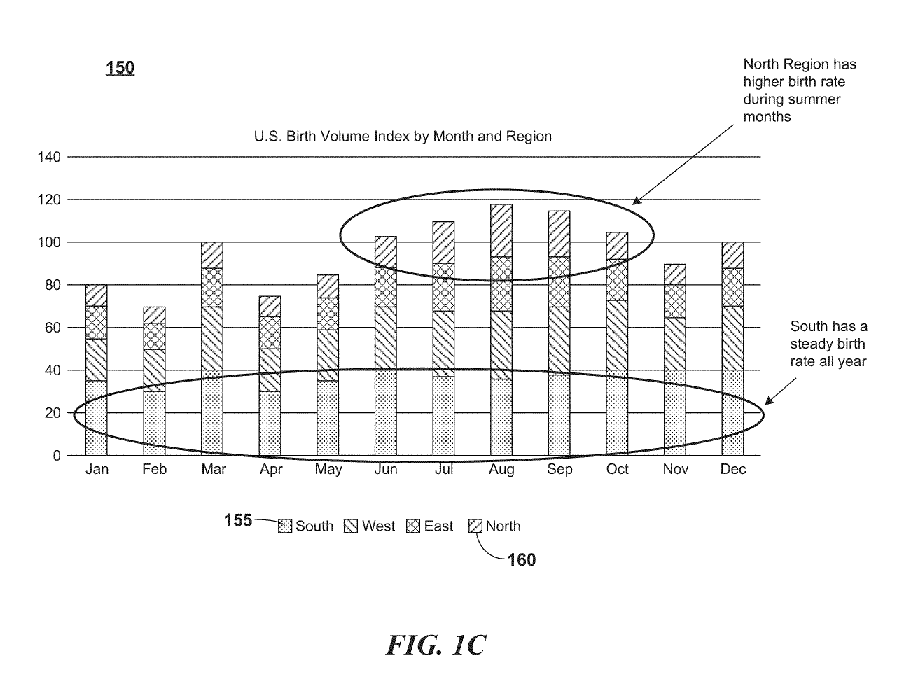

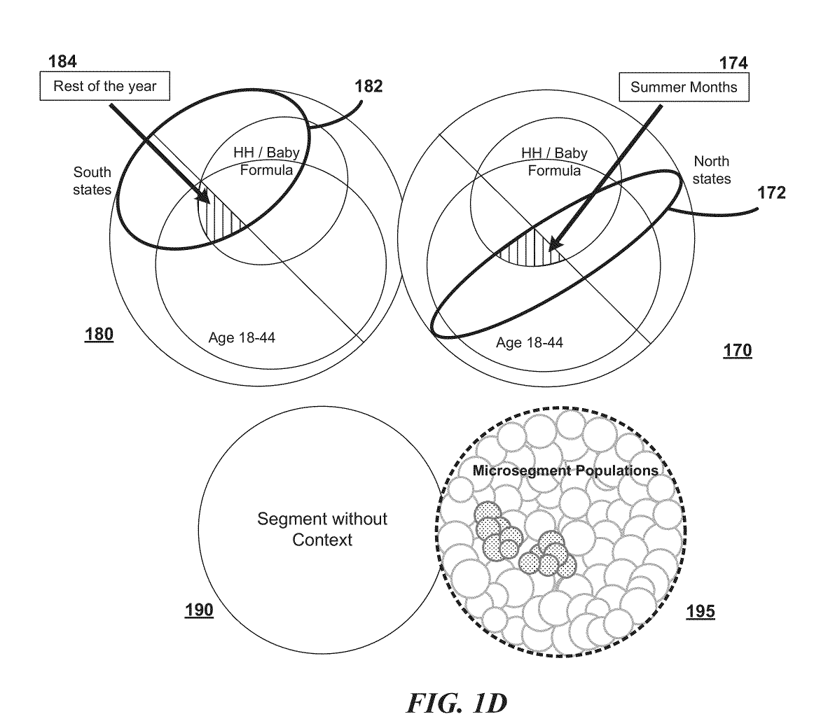

FIG. 1A is a plot depicting a relationship between advertising campaign sophistication and the ability to deliver relevant information in delivered advertisements to consumers. An advertisement more related to a consumer's preferences is more likely to meet or exceed a consumer's expectations and ultimately generate more conversions. Three different approaches to campaign advertising can be used to present relevant messages to shoppers: Segmentation 105, Personalization 110 and Contextualization 115. Each approach can be focused on a different way of relating to a shopper. However, a chasm exists between each of them due to the need for different data sets, processing techniques, and campaign management toolsets. Because each approach approaches relevance in a fundamentally different way, each can be applied to campaign advertisement independently or in junction with others.

In general, as reflected by the trend line on the graph of FIG. 1A, more sophisticated approaches to advertising campaigns are required to meet increasing consumer demand for advertisement relevancy. As digitally-connected customers encounter more and more promotions, offers, notifications and other advertisement material than they can process, relevancy is increasingly necessary to influence consumers to make a purchase. In general, the more an advertising campaign relates meaningfully a shopper, the more likely it is to be personalized and contextually relevant to that shopper.

The least sophisticated advertisement campaigning efforts may only apply “segmentation” 105. In “segmentation” 105, consumers are divided into different groups and targeted with advertisements based on general characteristics of those groups. A Venn diagram 125 in FIG. 1B depicts a traditional segmentation approach to a campaign for baby formula. In the diagram 135, the population of all states is initially segmented by gender (male/female) then by age (ages 18-44/ages other than 18-44). Finally, a segment of households with newborns is identified. The intersection of those three segments identifies a targeted audience segment 130 for advertising purposes, namely women between 18-44 in a household with a newborn. The depicted segmentation approach assumes all household with newborns will want to buy baby formula, and that segments outside of the targeted audience segment 130 (e.g., men 18-44 in households with newborns) will not want to purchase baby formula. Although such segmentation allows an advertiser to reach groups of individuals that might be interested in a product, segmentation targeting is often overly inclusive and can include many consumers that would have no interest in the product.

Returning to FIG. 1A, the next level of advertising campaign sophistication is referred to as “personalization” 110. In “personalization” 110, advertisements are targeted to consumers based on additional information associated with each consumer that indicates there might be a propensity of the consumer to purchase the advertised product. For example, a consumer who bought a brand of razor is more likely to purchase the same brand of razor sometime in the future. As another example, a consumer that purchased shaving cream may be more likely to purchase a razor in the future. A Venn diagram 135 in FIG. 1B depicts a traditional personalization approach to a campaign for baby formula. In the diagram 125, the population of all states is initially segmented by gender (male/female) then by age (ages 18-44/ages other than 18-44). Finally, a segment of households that have previously purchased baby formula is identified.

The intersection of those three segments identifies a targeted audience segment 140 for advertising purposes, namely women between 18-44 in a household that has previously purchased baby formula. The depicted personalization approach assumes all households that have previously made purchases will want to continue to buy baby formula. Personalization of advertisements based on a shopper's past purchase behavior and profile therefore increases the likelihood that the advertiser is reaching a desired consumer. Unfortunately, personalization fails to take into account the timing of the particular advertisement presented to the consumer. For example, while it may be fairly predictable when to replenish a consumer's razors based upon their purchase cycle, promoting razors in November may not be ideal due to, e.g., a “Movember” event. This annual event involves the growing of moustaches during the month of November to raise awareness for men's health. Accordingly, based on other contextual factors, it may become evident that the consumer intends to participate in the Movember event and will not have reason to purchase razors in the near future.

As an example of the shortcomings of identifying potential audiences using segmentation and personalization, FIG. 1C depicts one example of specific contextual data that can prove to be valuable to advertising targeting. FIG. 1C illustrates a typical annual chart 150 of the Birth Volume Index of the U.S. newborns by month and by region. As depicted in the chart, Southern states 155 typically produce a consistently high birthrate year round and consequently provide a better overall market to target. However, in the summer months, the birth rate percentage in the Northern states 160 actually jumps much higher than the Southern states 155. The temporary growth in the north during the summer months actually provides an even better opportunity to generate more sales. Accordingly, a system that recognized these contextual discontinuities and could recommend promoting baby formula in the north more heavily during the summer months would provide superior performance over prior targeting techniques. Because of these gaps, segmentation and personalization targeting techniques frequently fail to deliver advertisements to consumers in an optimal fashion.

Returning to FIG. 1A, to overcome the shortcomings of segmentation and personalization, the system disclosed herein applies “contextualization” 115 to target advertisements. Contextualization means that the system uses contextual data associated with a consumer, with the products advertised to the consumer, or with the circumstances associated with a potential purchase by the consumer. Using “contextualization” 115, an advertiser is better able to target advertisements to the consumer. For example, advertising a sports drink to a consumer known to be runner on a Saturday in July when the temperature exceeds 90 degrees is more likely to result in a sale of the sports drink than when advertised to that same consumer on a Tuesday in December.

FIG. 1D is a set of Venn diagrams which depict how the use of contextual information can be applied to better target advertising campaigns, using the example again of the sale of baby formula. In the diagram 170, the population is initially segmented by age (ages 18-44/ages other than 18-44) and then by households that have previously purchased baby formula. Overlaid on top of that segmentation is a segment 172 reflecting households associated with a Northern region. As reflected by the contextual data presented in FIG. 1C, during the summer months advertising dollars for baby formula might be more effectively spent in the Northern region. As a result, during the summer months an advertiser may choose to advertise to the targeted audience segment 174 which is comprised of Northern households that fall between the ages of 18-44 that have previously purchased baby formula. In contrast, during the months other than the summer months, an advertiser may prefer to target the Southern region where baby births are more consistent year round. In the diagram 180, a segment 182 reflecting households associated with the Southern region is therefore overlaid onto the depicted data. During non-summer months, an advertiser may choose to advertise to the targeted audience segment 184 which is comprised of Southern households that fall between the ages of 18-44 that have previously purchased baby formula. Thus, various embodiments of the disclosed system and methods offer improved targeting of consumers at points where they are more likely to consummate a purchase of the advertised product.

It will be appreciated that the diagrams 170 and 180 are fairly simplistic representations of only a single contextual factor (birth rate information) covering a broad geographic scope (Northern and Southern regions). As will be described in additional detail herein, the disclosed system uses contextual factors to identify multiple micro-segments of consumers that are likely to purchase an advertised product and combines the micro-segments to generate a targeted segment to pursue. Rather than target an entire segment 190, for example, the use of contextual information allows for more precise targeting. As graphically shown in segment 195, only a fraction of the consumers in the broader segment 190 might be targeted based on specific contextual information which indicates that they are more likely to be interested in the corresponding product being sold.

### System Overview

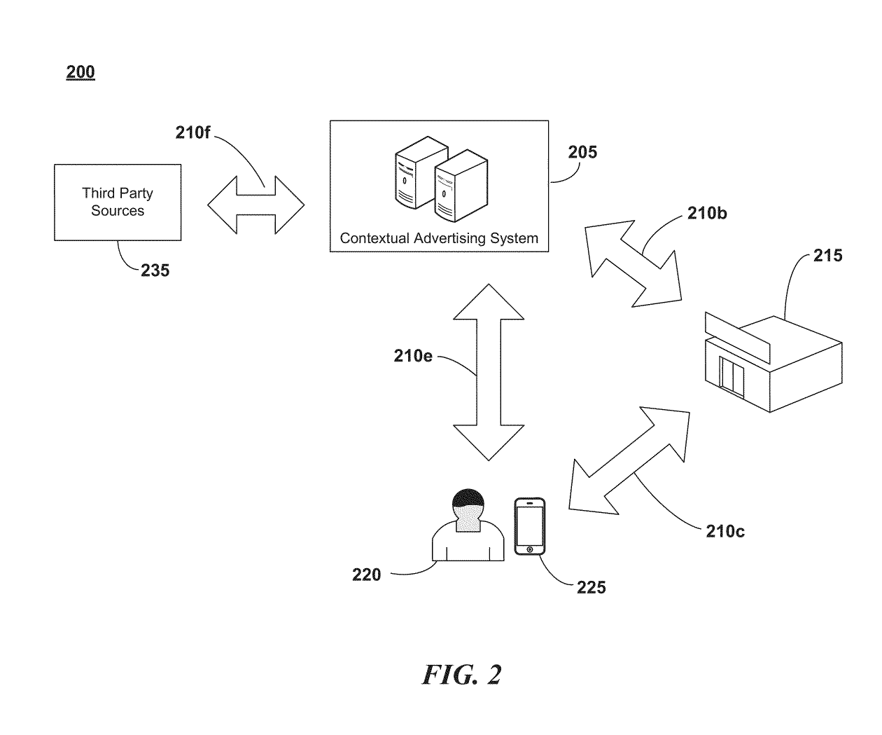

FIG. 2 is a block diagram depicting the topology 200 of an environment in which a contextual advertising system 205 and methods may operate. A consumer 220 may possess a user device 225, e.g., an iPhone™ or Android™ smartphone, tablet computer, laptop, desktop computer, wearable devices, etc. The consumer 220 can have access 210c to a set of outlets 215 at which products can be purchased. The outlets can be physical store locations or can be virtual locations accessed, for example, via the Internet, via mail order, etc. The user device 225 can provide 210e data directly (or indirectly through an intervening system) to the contextual advertising system 205 using monitoring tools, self-reporting by the user, etc. Such data can include records of application purchases, position information, contact information, social network postings, etc. The outlets 215 can also report 210b purchases, engagement, inventory, and other reference data regarding their stores and customers, etc. to the system 205. Finally, various other third party sources 235 can also be relied upon to provide information 210f to the system 205.

For example, a weather service may provide information regarding current and predicted weather conditions at geographic locations relevant to the consumer 220. As another example, a network may present information regarding its programming schedule for content that may have been viewed by the consumer. Third party data 235 can also include data from services used by the consumer 220, e.g., a social network service which provides user information. The contextual advertising system 205 consolidates these and possibly other sources of information as described herein. As will be described in additional detail herein, the gathered information is used by the system to target advertisements to the consumer at times/locations when/where the advertisement is likely to be the most relevant to the consumer.

### System Overview—Data Flow and Components

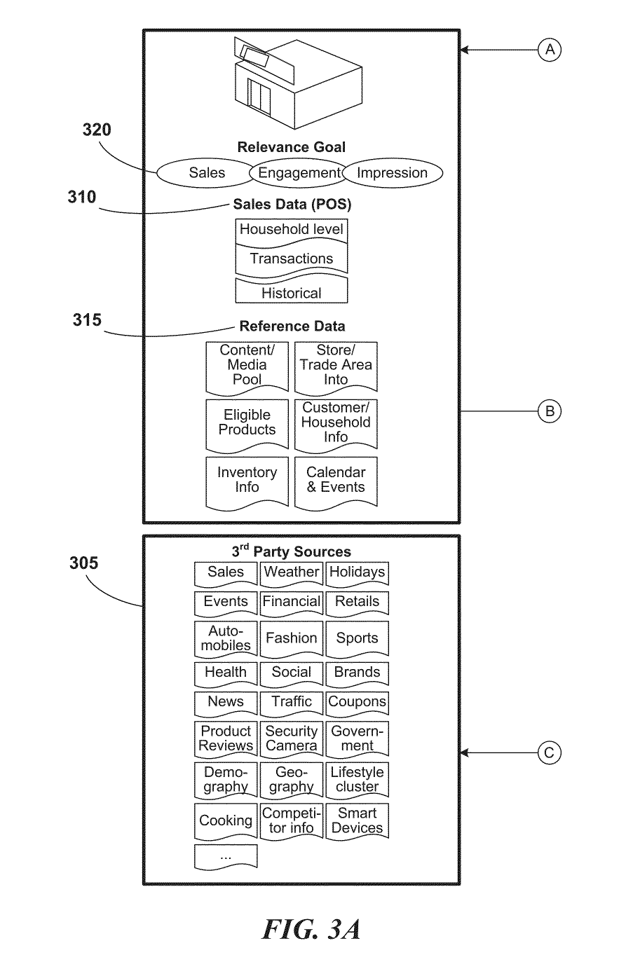

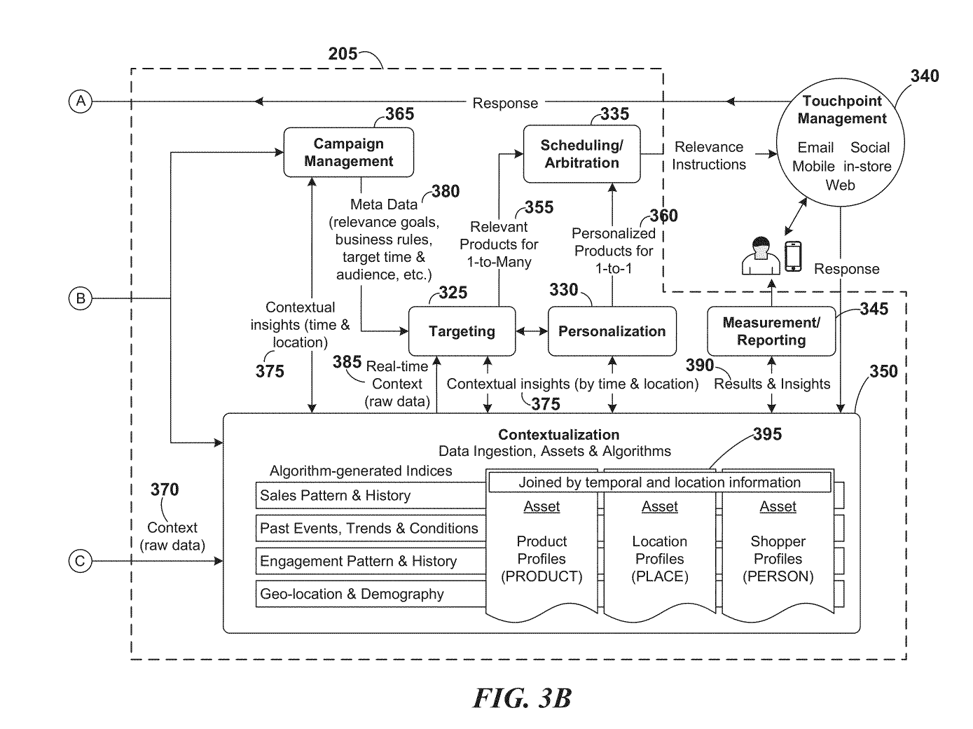

FIGS. 3A and 3B are a block diagram depicting the data flow from various sources through a context processing system 205 to generate an advertising campaign as can occur in some embodiments. The system 205 collects and processes different categories of data, including contextual data pertaining to products, places, and persons, which is used to assess the context of past purchases of consumers and better predict the likelihood of future purchases. The contextual data is then used to better target consumers with advertisements.

Specifically, FIGS. 3A and 3B depict three different types of data being collected or received. Third party data 305 is gathered from various sources, such as Google®, Facebook®, Data Aggregators (e.g. Acxiom®, Experian®, Infogroup®, etc.), weather resources (e.g., Weather.Gov), the CDC (Centers for Disease Control), etc. The third party data 305 can include sales data and buying propensity from data broker (e.g. Nielsen® or IRI®), historical weather information (associated with physical locations), record of holidays in different geographies and societal groups, local event information (e.g., concerts, festivals, sporting events), health information (e.g., the type and location of certain health outbreaks, such as the seasonal flu, strep throat, etc.), search and news trends, product reviews, traffic conditions, surveillance (e.g. security, camera/video), government programs, available coupons in the market, geographic, demographics, psychographic, financial activities, user interest, statistics and competitive intelligence of various industries (e.g. retail, financial, automobile, etc.), and other similar types of data.

The system can also collect point of sale information 310, such as past sales information from different retail organizations directly (rather than, e.g., via a data broker). The historical sales information can include sales by different categorical levels (e.g. department, category, sub-category, brand, stock keeping units, etc.) by household and shopping baskets, quantities, prices, locations, the times at which products sold, etc. The system can also collect various reference data 315 directly from these retail organizations. The reference data can include, e.g., such data as the current inventory levels at various retail locations, information about households and consumers in certain physical locations, general textual or graphical descriptions of products or services, etc.

The third party data 305, POS information 310, and reference data 315 can have both an express or implied location and a temporal component. That is, elements in each of these datasets may be associated with a particular location and a particular time or time period. The system 205 associates a timestamp with each piece of collected data, if the data does not already have a particular time or time period associated with it. The timestamp can be a particular instance in time (e.g., Tuesday, July 5th at 12:23 pm) or can be associated with a period of time (e.g., Q3 2013). At least some of the received data may already have associated timing information, which the system may convert to a common format for comparison across all data sets. To the extent that the received data does not have associated timing information, however, the system can assign a time or timeframe to the received data. As a default and in the absence of any other information, the system may assign the date that the data is received by the system. Associating a timestamp with each piece of contextual data allows the system to subsequently improve campaign targeting using the temporal data as described herein.

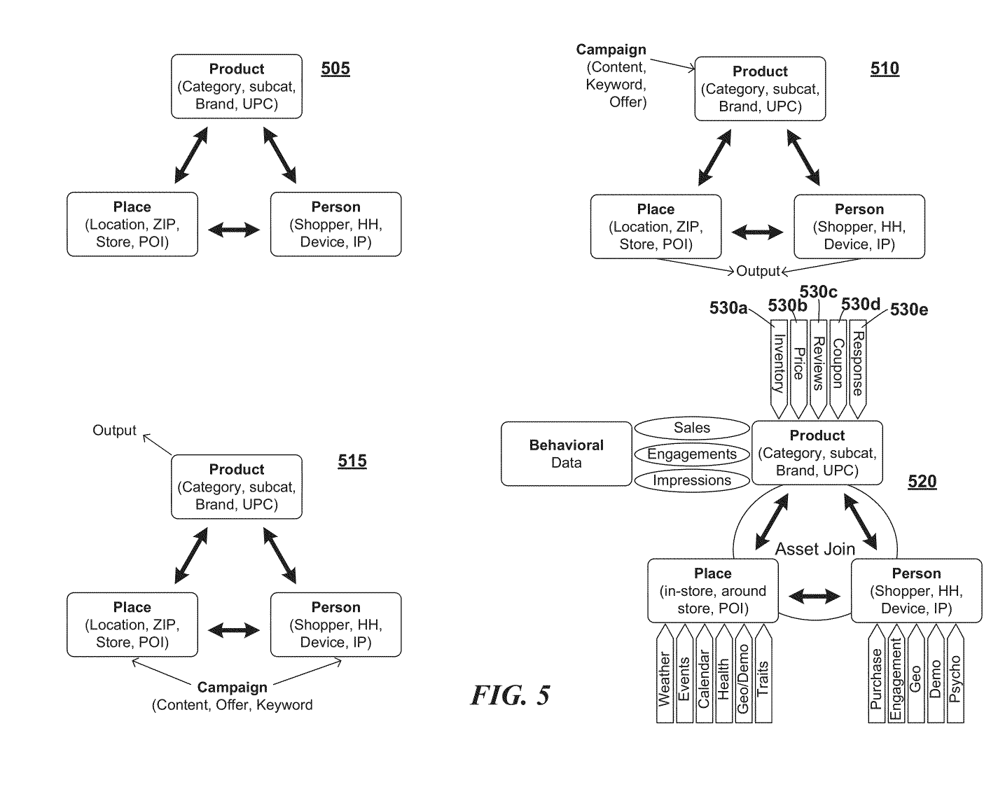

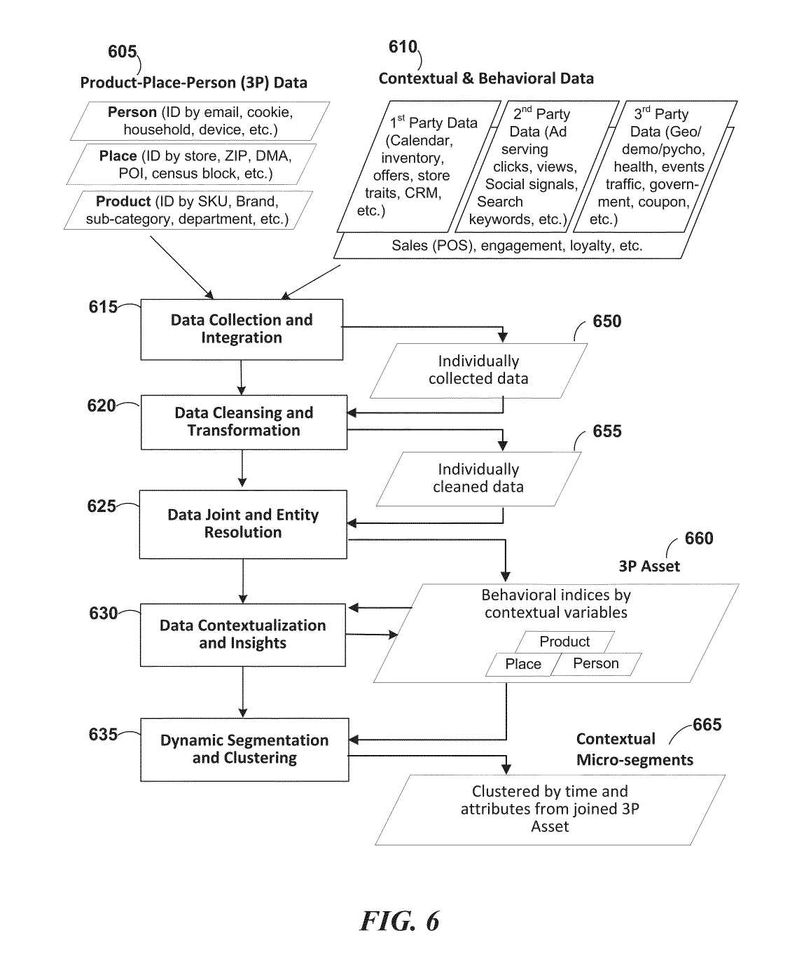

The system 205 also associates a particular location with each piece of imported data (if a location is not already associated in the imported data). The location may be received in a form allowing it to be mapped to a desirable granularity of location unit (e.g. zip/zip+4 code, census block, etc.). For example, the received location information might be a reference store number that allows correlation with a street address, GPS coordinates, a name of a city, etc. As discussed herein, zip codes are the lowest level of granularity applied in some embodiments of the system. The system therefore assigns a zip code to received data so that the product, place, event, etc. is associated with a physical region. Depending on the type of received data, the system can use a look-up table or a commercial service to convert received position information into a zip code. For example, if a street address is received, the system may use a database which maps addresses to zip codes, such as offered by the US Postal Service or other provider of location services. As another example, the system may receive GPS information which might be directly mapped to a zip code or first converted into an address and then to a zip code. In some circumstances, data associated with a certain address may be allocated to multiple zip codes. For example, a large box retailer may be located at a location where it receives customer traffic from multiple surrounding neighborhoods. In that case, the system may allocate the sales data associated with that store to the surrounding zip codes using an algorithm that is based on distance and population. As a simple example, if a particular store is surrounded by three zip codes (zip1, zip2, zip3) that have populations of X, 2X, and 3X and distances of Y, Y, and 2Y from the store, the system may allocate the store sales using an algorithm that is directly proportional to the population and inversely proportional to the distance. For example, such an algorithm may generate an allocation of zip1=(X,Y)=22%, zip2=(2X, Y)=44% and zip3=(3X, 2Y)=33%. An additional description of the processing associated with the received contextual data is described in further detail with respect to FIGS. 5 and 6. Using this historical information the system builds a dataset (“Assets”) 395 for targeting.

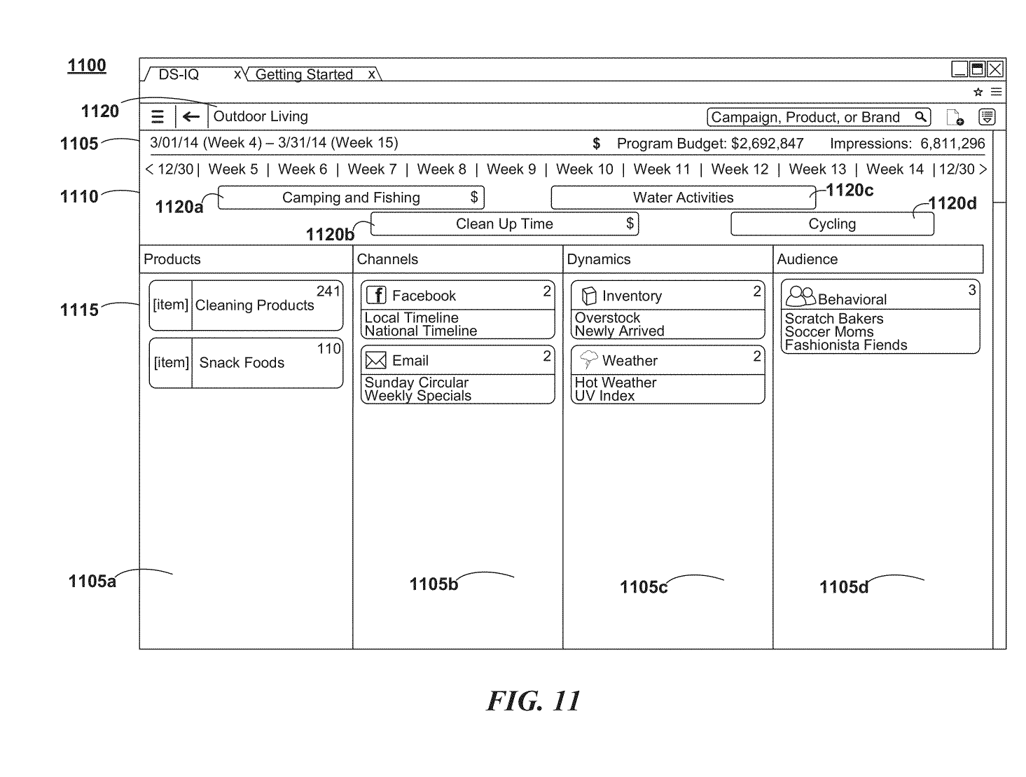

The system 205 also receives information about a desired campaign goal 320 from, e.g., an advertiser. The campaign goal can include a timeframe for a campaign, a product or set of products (e.g., a product category) for a campaign, and one or more channels and touchpoints through which the campaign is to be distributed. Additional details about an interface for receiving information from an advertiser about a desired campaign can be found in FIG. 11.

Once the data has been received by the system 205, the system processes and stores the data in a manner that allows the data to be accessed via various indices. A contextualization module 350 can store the data organized by product (e.g., as identified by a unique product identification code, UPC), location (e.g., as identified by a unique identifier that can be linked to a retail venue where audience are located), or shopper or device (e.g., as identified by a unique identifier that can be linked to an individual consumer or household). Various indices 375 are constructed for the data to facilitate analysis of the sales patterns and history, engagement patterns and history, impact of past events, trends, etc. Correlations between the product data may be identified by time and location. Additional details of the contextualization analysis performed by the system are described with respect to FIGS. 5 and 6.

After analysis by the system 205, the stored data that consists of contextual insights 375 is used by the system to generate audience segments and targeted advertisements for advertising campaigns. A campaign management planning module 365 allows marketers to communicate and plan out their campaign goals, products, target audience set, preferred contextual variables, channels and touchpoints to reach their audience, ad contents (i.e. content, message, offer), and other specific business rules as referenced collectively as meta data 380.

A targeting module 325 can access the stored contextual insights expressed in the indices by time and location 375 to identify an appropriate product or products to target to an audience 355. This determination can be made based upon the received campaign metadata 380 and stored contextual information associated with the desired product or products in the campaign. For example, the system can identify “salty snacks” as a group of products to target to likely male shoppers before the World Cup.

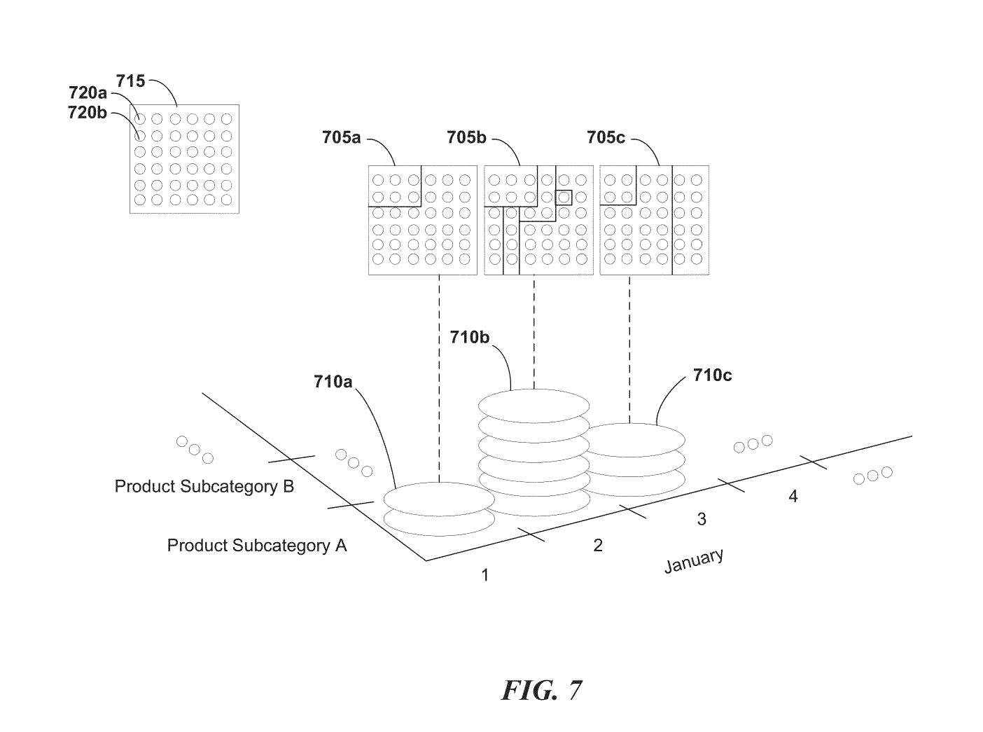

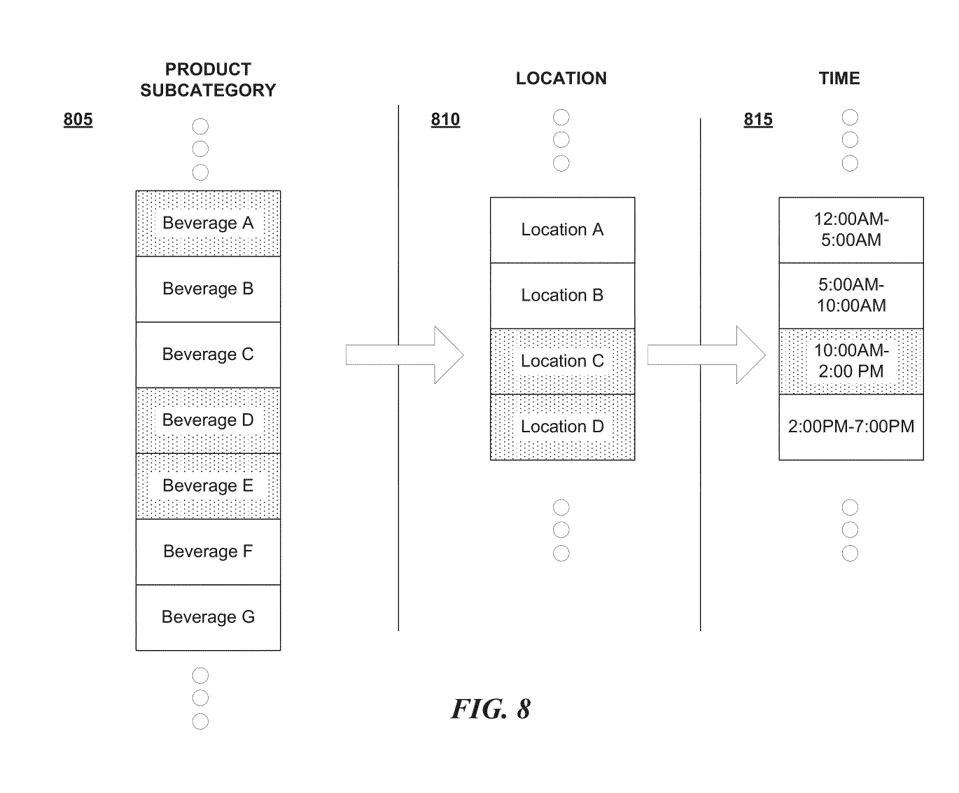

Once the desired audience 355 is identified by the targeting module 325, the system can access the stored contextual insights 375 and combine them with real-time or near real-time context 385 to produce a set of products or messages that are relevant to an audience set (e.g., in a one-to-many marketing scenario). Similarly, a personalization module 330, working independently or in conjunction with targeting module 325, can access the stored contextual insights 375 to identify a particular product from the selected product or products to target to each consumer or consumer household within the targeted audience (i.e. one-to-one marketing scenario). For example, the personalization module 330 can determine that household “A” should be targeted with the particular salty snack “pretzels” from within the specified product category. As will be described in additional detail with respect to FIGS. 7 and 8, the selection of the optimum audience to target can rely upon the time and location at which the advertisements will be presented.

A scheduling/arbitration module 335 receives the recommendations from the targeting and personalization modules and schedules appropriate advertisements and arbitrate conflicts within or across the various channels 340 (also referred to as “touchpoints”) specified by the campaign. Though depicted here separately from the system 205 (as the domain expertise for each channel may often be distinct from the systems' functions), in some embodiments, the system 205 may integrate various channel communication functionality. To the extent that scheduling or channel conflicts arise, the scheduling/arbitration module 335 reconciles the desired channels across or between various campaigns. For example, a retail organization may want to run a digital coupon campaign to target its customers via weekly email on their mobile devices when they shop in or near the retail organization's store. The retail organization may wish to issue 10 eligible one-time redeemable coupon offers that are highly relevant to a particular shopper as determined by targeting module 325 and/or personalization module 330. Due to the constraint of each touchpoint's message display real-estate, in some embodiments the scheduling/arbitration module 335 can anticipate the display limitations, and only select 2 coupons to be embedded in the weekly email and 1 coupon on the mobile devices. Furthermore, after the shopper in the store has redeemed the coupon previously presented on the shopper's mobile device, the scheduling/arbitration module 335 can identify a different coupon to present next time (since the previously selected coupon will no longer be relevant). The performance of campaign advertisements and responses delivered via different channels may be measured by the system 205, the retail organizations 215 or third parties 235, and used as feedback by the system to improve the targeting and personalization algorithms.

The system 205 can also include a measurement/reporting module 345 which generates reports that can be distributed to advertisers to apprise them of the performance of the campaigns, any additional shopper insights and the effectiveness of the desired targeting.

It will be appreciated that on a periodic basis the system 205 may remove data, replace data, or adjust the value of certain data from assets 395 as the data ages. Doing so ensures that system targeting is based on more recent data which may better reflect certain trends in the marketplace. Depending on the source of the data and the perceived longevity of the underlying product, location, or person information, the system may account for data aging using one of multiple techniques. For some data, the system may apply an absolute age limit on the data, deleting data that is older than the limit. For example, the system may discard any data that is over 2 years old in assets 395. For some data, the system may remove data only when a newer replacement data set is received. For example, for certain data that is received on a yearly basis, the system may discard the previous data set when the new data set is received. For some data, the system may apply a weighting factor to the data so that the data has less impact on targeting the older that it becomes. For example, the system may apply a weighting factor so that data is deprecated by 50% when it is more than one year old, by 75% when more than 2 years old, and by 90% when more than three years old. It will be appreciated that the weighting factor may be a linear decay, a logarithmic decay, or other function. For some data, the system may apply an enhancement factor to the data so that the data has a greater impact on targeting. For example, it may be beneficial for particularly recent data (e.g., data received within the past two weeks) to have a greater impact on targeting than other data. As a result, the system may apply an enhancement factor such as 110% to the most recently received data so that the most recently received data has a greater impact on targeting than other data.

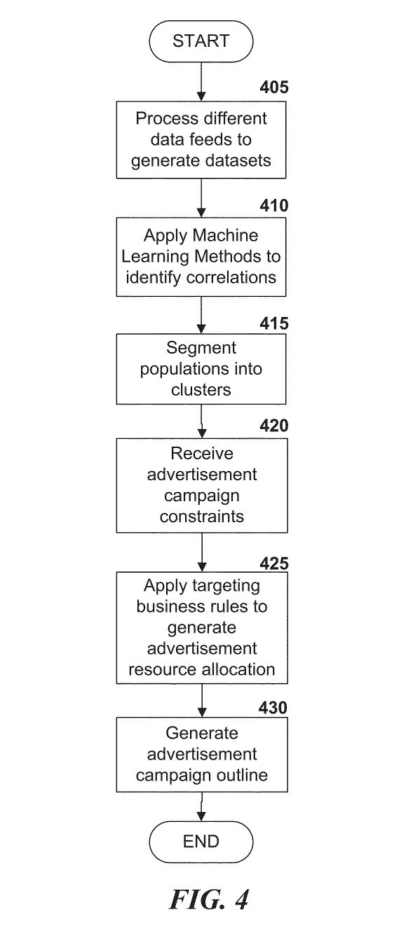

FIG. 4 is a flow diagram depicting an analysis and advertisement resource allocation process during the campaign planning stage at a high level as can be implemented by the system 205 in various of the disclosed embodiments. Using this process, an advertisement campaign planner can determine, e.g., the best times, places, products as well as the particular consumer populations that would be most affected by a contemplated advertising campaign. At block 405, the contextual targeting system 205 processes various data feeds for use in targeting. The data feeds can be received, e.g., from third parties, from sales outlets, from devices associated with consumers, etc. to generate datasets. The datasets can reflect organized, but uncorrelated, sets of data (e.g., raw weather patterns, raw purchasing data, etc.). The generation of datasets is described in additional detail with respect to FIGS. 5 and 6.

In general, each data feed can be represented as a variable before the system 205 applies. Machine learning methods can be applied to this dataset at block 410 to determine correlations between these variables. The machine learning methods can consequently identify the variables' influence including their ability to trigger statistically significant changes in consumer behavior. For example, as an ultraviolet (UV) index becomes higher, one may naively infer that sunscreen products should be promoted. However, after applying the machine learning predictive modeling, the system may discover that a very high UV index (8, 9, 10) and even an extreme UV index at 11 do not generate more sales of sunscreen products in, e.g., Miami, Fla. However, a modestly high UV index (6, 7) may generate more sales of sunscreen in Seattle, Wash. The system may also determine that when a very high UV index (8) was reached, sunscreen products may be selling at an usually high rate in Seattle. As demonstrated by this example, the machine learning may be specifically configured to recognize outliers and irregular behavior associated with contextual patterns.

At block 415, the system segments the consumer data into population clusters for different time periods (e.g., a “dynamic micro-segment” as may be found in a cluster of one of sets 710a-c). Once the population clusters have been determined, at block 420, the system can consider the constraints and exposure goals for a particular advertisement campaign. For example, an advertiser may wish to generate 20,000 exposures across a three month time frame for a beverage product in the Pacific Northwest.

At block 425, the system performs “targeting” using business rules to identify a most effective approach to implementing the desired goals. As discussed in greater detail herein, these rules can indicate that only outlets having the beverage in stock are to be considered when assessing the previously acquired segmented datasets (e.g., clusters of sets 705a-b). Targeting rules can incorporate many factors, e.g., product uniqueness, location relevance, the product category's relative sales volume versus other substitute categories of products (e.g., a product's importance to a store), product relative sales at the locations versus other locations, contextual variables as preferred by the marketers as well as identified by the system via predictive machine learning insights, etc. In addition to a standard scoring process in the targeting module, ad hoc business rules such as promotion based on certain inventory conditions (e.g. excess stock, out of stock) and frequency of a product's appearance to shoppers (e.g. to void repeated impressions in consecutive days), and adjacency to a competitor promotion, etc.

Once targeting has reshaped the segmented data appropriately, the system generates a campaign outline at block 430 for an action plan to implement the campaign. For example, the outline can specify when and where to present advertising to certain consumer population segments. The system can also present a likelihood associated with various aspects of the outline to indicate the expected success in achieving the various campaign goals based thereon or embed an experimental design for A/B testing, etc.

### Product-Place-Person Contextual Data Asset Design

FIG. 5 is a block diagram depicting various “Product-Place-Person” data consolidations as can be implemented in some embodiments. As depicted, a contextual dataset can be constructed in some embodiments based on 3 primary assets—“Product”, “Place” and “Person” 505. Each of these assets can cover a broad set of variations. For example, a “Product” asset can be indexed at different aggregation levels based on different retail organizations' taxonomies for their product data or by an international standard organization such as GS1 Global Product Classification (GPC). Such variations could include, but are not limited to, department (in which the product is sold), product category, product subcategory, product brand, SKU (stock unit), etc.

A “Place” asset can represent a location (e.g., a physical location or a virtual community) where groups of shoppers experience a one-to-many advertising scenario. For example, assets could be indexed at the retail store, a point-of-interest, an online forum, a digital out of home billboard, DMA (direct marketing area), ZIP code, a census block, etc.

A “Person” asset can represent the one-to-one nature of an advertising relationship. The “Person” asset can be indexed to actual consumers using an identifier, to protect the consumers' privacy. For example, a person can be represented by a loyalty card, a household address, an email, a mobile or user device ID, etc.

These three primary asset datasets can enable a flexible approach to support various common advertising scenarios. Such scenarios can include, e.g.: given a set of products, to whom, where and when these products should be featured; given a planned marketing event for a store, the products that should be promoted; given a shopper, what to feature on a particular touchpoint in a particular moment, etc.

As conceptually indicated in topology 510, campaign inputs (campaign content, key words, offer parameters, etc.) can be input as “Product” assets. Correspondences between product information and the place and person databases can then be used to determine an output indicating the appropriate places and times at which to advertise to a population segment.

Conversely, in some embodiments the process flow can occur in reverse. For example, as indicated in topology 515, a plurality of campaign inputs can be used to identify appropriate places and persons to market to. Relations between the persons, places, and products can then be used to identify an appropriate product to market to the specified demographic and location. In topology 505, “Product”, “Person”, and “Place” asset information can be interrelated between various database tables to form indices by time and location.

Once a primary Product, Place and Person asset set is established an explicit or implicit timestamp is appended to the data. For example, topology 520 depicts fields that may be logically appended to each of the assets with an explicit or implicit timestamp. For example, retail organization-supplied inventory 530a and pricing 530b data, product reviews 530c from various internet web sites and social networks sourced data, manufacturer-provided coupons 530d, and customer reviews 530e, can all be joined with the Product asset as part of the asset's “attributes”. Similarly, weather, local and sports events, regional health-related conditions can all be “attributes” of the Place asset. The Person asset can be associated with attributes relating to personal or individual household consumption pattern and various demographic, lifestyle information.

The system can also determine various behavioral insights from past contextual data patterns. For example, the system can identify associations within shopper behavioral data. Such behavioral data can include purchase (e.g. sales velocity, sales frequency, etc.), engagement (e.g. email open, offer redemption, Facebook ‘like’, Twitter re-tweet, etc.) and impression (e.g. traffic counts, facing recognition in front of signage, etc.) features. In an example SQL implementation, a JOIN operation can be used to search fields appearing in each of the product, place, and person tables. In this manner, datasets can be combined that feed into predictive analytics algorithms to construct various contextual insight indices 375. This can be used to support campaign planning, targeting, personalization and reporting as described in FIGS. 3A and 3B herein.

### Preparatory Processing for Segment Preparation

FIG. 6 is a flow diagram illustrating a data processing technique as can be applied by the system in some embodiments. Generally, the depicted features of FIG. 6 correspond to blocks 405, 410, and 415 of FIG. 4, where data is consolidated from disparate sources into a form suitable for segmentation into clusters at block 415 (corresponding, generally, to clustering 635 and micro-segment generation 665). The data processing can contextualize raw, often noisy data into a clean Product-Place-Person asset 520 and apply machine learning algorithms to generate micro-segments. The micro-segments group similar shoppers by their behaviors under various contextual conditions for planning and targeting. A micro-segment is a subset of a population (households, individual persons, etc.) identified using contextual data, which indicates the subset's relative proclivity for responding to a product or product segment at a time and/or location as compared to another subset. For example, a population may be divided into several micro-segments for a given day, the micro-segments arranged in a total order to reflect the most responsive and least responsive customers in the population (although a more general partial ordering of the segments may be possible in some embodiments). The response may be a conversion (e.g., a product purchase) or another advertisement campaign related task (e.g., the population member's receptivity to advertising, ability to virally spread new of a product, etc.). Each micro-segment may have an associated score which reflects the relative proclivity of the population subset represented by that micro-segment to respond in the desired fashion. Micro-segments may vary in size, but typically are fractions of a segment size typically generated by traditional audience segmentation approaches. For example, each micro-segment may have thousands, tens of thousands, or hundreds of thousands of customers, rather than millions of customers. Micro-segments may, of course, be smaller or larger than the noted range depending on the size of the population being divided and other factors. As will be discussed in additional detail below, multiple micro-segments are typically selected by the system to build a targeted audience of a desired size.

Primary data 605 can include, e.g., product information, product or consumer location information, and consumer details or potential consumer details for various products. Behavioral and Contextual data 610 can include measurable behavioral data from shoppers' purchases and engagement with various outlet infrastructures. The contextual data can come from, e.g., first, second, and third party data. First party data can include, e.g., calendar data, inventory data, current offers at points of sales, etc. Secondary party data can include, e.g., online advertisement impressions, social network signals, etc. Third party data can include, e.g., geographic information, health information, traffic information, etc. The Product-Place-Person (3P) data 605 and the Behavioral and Contextual data 610 can be provided to a data collection/integration module 615. The data collection/integration module 615 then identifies and collects data from various sources. Various data collection approaches can be applied, including scraping information from a web site, calling APIs provided by data sources (e.g., provided by social networks), manually querying and downloading information from sources, etc. The data collection/integration module 615 then generates collected data 650 that can be deposited into a memory storage. The individually collected data is processed by a data cleansing/transformation module 620 which cleans and refines collected data to extract and transform raw data into meaningful cleaned data 655. The individually cleaned data 655 has an explicit or implicit timestamp and location information which facilitates a subsequent data joint process.

The data joint/entity resolution module 625 joins one or more cleaned datasets 655 with Product-Place-Person data 660 as illustrated in FIG. 6. Entity resolution (matching) algorithms can be deployed in the data joint/entity resolution module 625 to identify and group/link different manifestations of the same person, place or product (e.g., to avoid redundant characterizations of a same event and to consolidate data regarding same individual from across datasets). The same person can be identified in different ways, e.g., by recognizing individual names, email addresses, social network accounts, etc. Similarly, the same location can be inferred, e.g., from different web pages providing differing descriptions, but each using keywords associated with a same business. References to a same product in different product descriptions, images, etc., can also performed using recognition methods.

Ambiguity regarding identity may be pervasive due to name/attribute ambiguity, abbreviation/truncation, or data entry error. Such discrepancies are commonly found in census record, government data, web searches, different retail organizations' proprietary customer database and product dictionaries, etc. In some embodiments, entity resolution algorithms rely on a probabilistic likelihood function (e.g. a regression function) formed from combining various common attributes of matching objects. Supervised machine learning techniques with pre-trained sample data sets can be employed to run through multiple collected data feeds. In this manner, these techniques can maximize the probability that multiple entries are referring essentially to the same object. Entity resolution may require heavy text analysis and can often be assisted by leveraging various established frameworks as is known in the art (e.g. Apache Lucene/Solr™).

Once a cleaned 3P Asset 660 is created, a data contextualization/insights module 630 applies predictive analytics to create various indices. These contextual indices indicate a likelihood of repeated behaviors under similar contextual conditions (e.g. likely purchase or engagement under cold weather by time and location). These contextual indices can represent predictive behavioral patterns and contextual insights and can be stored as part of the joined 3P Asset 660. The 3P asset and its indices can then be used for subsequent planning and further audience segmentation and targeting.

A dynamic segmentation/clustering module 635 applies machine learning algorithms to classify and cluster similar shoppers from the contextualized 3P Assets 660. The machine learning algorithms generates micro-segments 665 based upon attributes and behavioral/contextual indices.

### Segmentation Overview

FIG. 7 is a three-dimensional plot of an example segmentation result using contextual data as may be generated by the system. In the example, a population 715 of 3600 individuals is depicted, with each circle 720a, 720b representing a hundred individuals. The population is to be segregated based upon each individual's general proclivity to purchase a given subcategory of product in a given time period. In the depicted example, sets 710a, 710b, and 710c of population clusters (or micro-segments) are shown for “Product Subcategory A”. Each set is illustrated as a stacking of population clusters to reflect the total or partial ordering of the clusters in each set. Each cluster within each set 710a, 710b, and 710c reflects a group of individuals that are likely to purchase a product that falls within the corresponding product subcategory. For example, on the first of January, the population generally consists of two clusters as reflected by the set 705a. The first cluster may indicate a portion (e.g., six hundred individuals) of the population with a 95% or higher likelihood of purchasing a product. The second cluster (e.g., comprising three thousand individuals) may reflect the remainder of the population. Finer gradations may be possible. For example, on the second of January, six clusters were identified as reflected by the set 705b. The six identified clusters, may represent, e.g., the portions of the population with likelihoods of: >=0.95; <0.95 and >=0.85; <0.85 and >0.75; <0.75 and >=0.65; <0.65 and >=0.55; and <0.55 of purchasing the product subcategory. The granularity and consequent number of clusters may be based upon thresholds set by a machine learning practitioner, by an advertisement planner, or by the system. Because of the depth of data gathered by the system, an individual or household appearing in one cluster one day may appear in another cluster on a different day.

Though only a handful of clusters are depicted in FIG. 7 to facilitate understanding, one will recognize that there can be hundreds or thousands of clusters for a given day depending on the size of the population being segmented. Moreover, rather than constructing clusters based on purchase likelihood, the clusters can also be generated based upon a predictive purchase velocity, sales velocity, or other metric. Although the example references “individuals” one will recognize that “household” and other levels of granularity may be used.

As a hypothetical example, Product Subcategory A can correspond to a particular beverage subcategory on the market (e.g., sodas). “Product Subcategory B” can refer to another beverage subcategory on the market (e.g., juices). Product subcategories can be organized hierarchically and clusters can be generated for each node in the hierarchy. For example, the system can also identify a proclivity to purchase “beverages” generally during a particular time period, or can analyze the data in order to generate a segmentation based on individual beverages (e.g., 7-UP®, Dr. Pepper®). As discussed herein, machine learning classification and clustering algorithms were applied to the 3P Asset 660 and its associated contextual indices in order to generate the depicted subcategory clusters or micro-segments. Following the correlation determinations provided by the machine learning phase, the system divided the population into different clusters for each time segment (here one day in a month) based upon the population's propensity to purchase each beverage subcategory on a given day. This breakdown facilitates subsequent analysis for a variety of advertising scenarios.

When an advertiser wishes to market a product falling within subcategory A during the specified timeframe (January 1st-3rd), the system uses the clusters identified in the sets 710a, 710b, and 710c to build an audience to target. That is, one or more of the clusters are selected by the system until a desired audience size has been constructed (Typically, of course, the population clusters reflecting the highest likelihood of purchase are selected over clusters having a lower likelihood of purchase). The number and granularity of clusters determines how many clusters must be selected by the system in order to reach a minimum or maximum number of desired target consumers for a campaign. In the depicted plot, for example, only a few clusters might be selected in order to create a target audience of 400 individuals. In contrast, a large number of clusters may be selected by the system in order to generate a target audience of 1500 individuals.

When an advertiser wishes to advertise a product subcategory not present in the dataset, the system can interpolate between the clusters of similar product subcategories to that which is advertised, or can use a more general clustering (e.g., the clustering of “beverages” generally) from which to identify targeted audience.

### Targeting Overview

FIG. 8 is a block diagram illustrating components in a targeting output as can occur in several of the disclosed embodiments. After an advertiser has selected a particular product subcategory to advertise, the system may identify which specific products within the selected subcategory should be advertised. For example, if the product subcategory that was identified was “juices,” using contextualization insights 375 provided by assets 395, the system can identify which specific products within the selected subcategory would be most likely to sell at the specified location and during the specified time. For example, as depicted in FIG. 8, the system can identify that of all the available products 805, only Beverage A, Beverage D, and Beverage E should be advertised. Among the available locations 810, the system can determine that only Location C and Location D are viable (e.g., based on one or more business rules). With regard to Time 815, the system can specify that advertisements would be most effective between the hours of 10 AM-2 PM. With his recommendation, the campaign planner can then allocate their advertisement budget accordingly (e.g., paying more for advertising at the times and places identified during targeting). Thus, different specific products can be more favorably identified based upon various contextual factors (e.g., outside temperature, time of day, disease outbreaks, etc.).

### Audience Segmentation

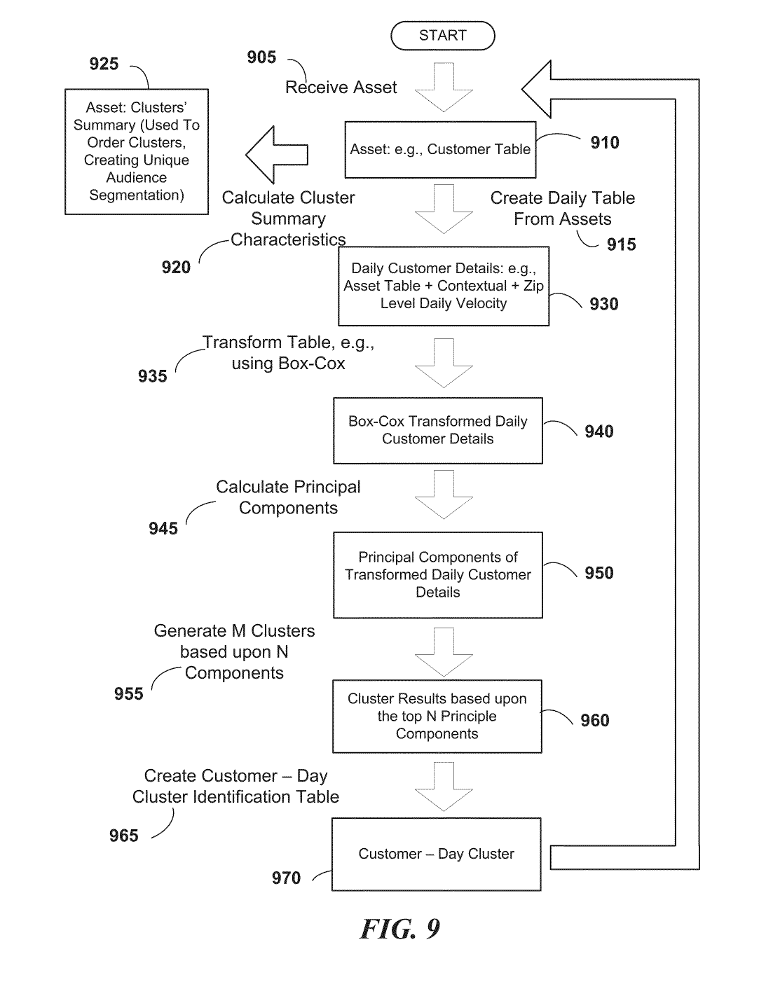

FIG. 9 is a process diagram illustrating a cluster segmentation process in greater detail as can be implemented in some embodiments (e.g., at block 415 of FIG. 4). Initially, the segmentation system may receive 905 an asset 910, e.g. a customer table constructed from the 3P asset 520. The segmentation system can calculate cluster summary statistics 920 and output the summary 925.

A daily table 930, reflecting the customer details at a daily level, may be created 915 from the asset. For example, behavioral data such as Sales Velocity Index data at the, e.g., day/zip code level will be joined to customer level demographic data and customer contextual-behavioral scores to create the dataset used to create the customer clusters for micro-segments. Thus, the daily table 930 can include data dimensions such as the sales velocity in the consumer's zip code at a given day, attributes regarding the customer, product, and purchase environment and contextual data related to that day/zip code, etc. Thus, the subsequent transformations and analysis operate upon a representation reflecting both contextual and non-contextual data.

Data normalization is a preprocessing procedure that can be applied in machine learning, where the attribute data are scaled so as to fall within a specified range, e.g., −1.0 to 1.0 or 0.0 to 1.0. Normalization before clustering may be applied in some embodiments as the daily table 930 could have, e.g., large differences in the magnitude of different attributes. Because of the attributes' different ranges, one attribute's value might overpower another one. Normalization can prevent outweighing attributes with large range like ‘salary’ over attributes with smaller range like age. This can equalize the size or magnitude and the variability of these attributes. To do so, the sales velocity index and other variables in the customer table can be transformed using, e.g., Box-Cox transform 940 to ensure each subcategory has a mean zero and standard deviation of one.

Using the contextual data in the data asset the system can create scores that describe changes in customer behavior given different weather conditions (hot weather, cold weather, snow, rain, etc.) and other contextual events (Black Friday, Easter, Local Sporting Events, etc.) at, e.g., the zip code level. Over time as the system learns more about individual customers the system can augment the table with custom contextual scores for each customer as well as perceptiveness to different forms of contact (email, Facebook®, mobile, etc.).

Once all contextual index scores are created and joined back to the dataset and prior to generate contextual clusters for micro-segments, a machine learning dimension reduction approach, e.g., factorization, or (as indicated here) Principal Component Analysis (PCA), can be applied 945 to identify an ordering of the most significant features 950. In some embodiments, once this process completes the system can use standard clustering procedures (K-means, hierarchal, etc.) to build the clusters.

Based on the top N components, clustering algorithms can be applied 955 to generate M clusters 960. The N components can be less than all the identified components, e.g., only the three most significant components (e.g., dimensions/eigenvectors corresponding to the largest eigenvalues). For example, PCA may have identified three components as being more significant than other components. The system can consult the data in the table 930 to determine the principal component values (e.g., the eigenvectors and eigenvalues) associated with each customer based upon their corresponding data for a given day. Customers whose data corresponds to the most significant component values can be placed during the clustering process in a higher probability cluster for that day, whereas customers whose data does not correspond to the most significant component values can be placed in a lower probability cluster for that day.

In some embodiments, after assigning the customer days to the M clusters the system can calculate the summary statistics for each cluster. For example, the averages for each subcategory from the sales velocity index, contextual score and demographic characteristic can be created from the raw data. This information can be used to score the clusters for each campaign to allow the ordering of customers for each campaign.

This association 965 of customers to clusters for a given day can be reflected in a customer-day table (e.g., a SQL table) indicating which customers correspond to which cluster for a given day. With the receipt of a new asset 905, the process can continue, refining the customer clusterings for each day 970 further. For example, in some embodiments customer-day tables can be generated for separate assets. A weighted average of the customer-day tables (the weights based, e.g., upon the reliability of the assets) can then be taken to determine the final customer-day table values.

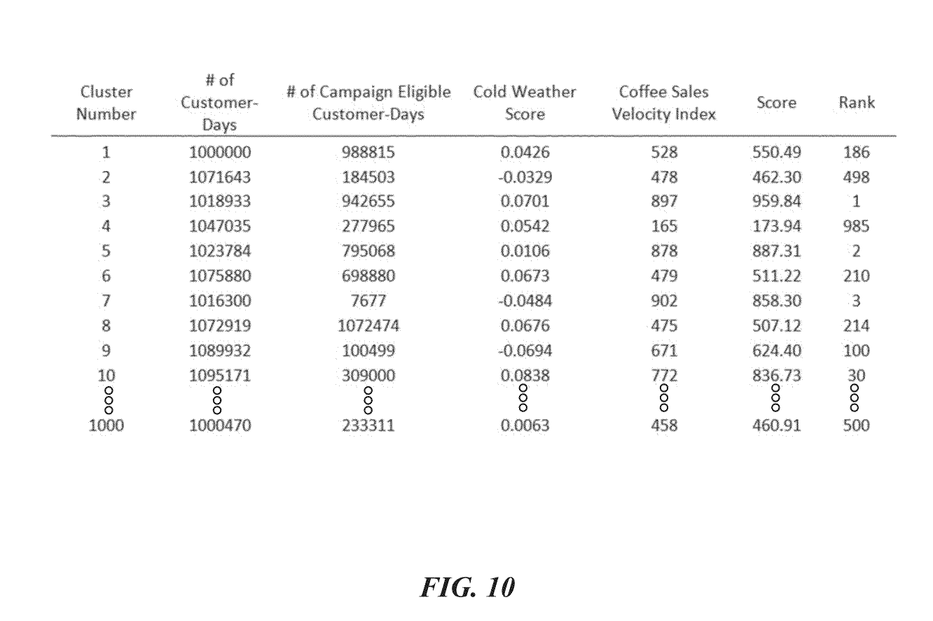

FIG. 10 is a table reflecting the results from an example cluster segmentation process as can be implemented in some embodiments. In this example, each segment is scored based on the average Sales Velocity Index and a cold weather score in relation to a coffee product. Based on campaign rules specified by the planner and/or geographic restrictions the system can restrict the number of eligible customer-days in each cluster. Here, a planner wants to run a campaign promoting coffee using the contextual variable “cold weather”. The planner has set the campaign time period of 12/2-12/9 for the state of California, Oregon and Washington and has a budget to reach 1,000,000 customers.

In response, the system can select the distinct customers from the top ranked cluster (i.e., cluster #3, which will provide less than or equal to 942,655 distinct customers after application of the business rules). The system can pull additional customers from the next most significant clusters (e.g., cluster #5) necessary to reach the 1 million customer goal.

Thus, segmentation provides a methodology for dynamically grouping and ranking customers based on, e.g., purchasing behavior, demographics and other contextual variables for a specific time of the year. Using the segmentation results, a campaign planner can direct the campaign to the best segment of customers for a given period of time. Application of business rules can prevent over-dependence upon the segmentation results by incorporating localized factors (inventory, holidays, etc.) into the analysis.

### Example Graphical User Interface Design for Contextual Marketing Campaigns

Traditional campaign planning tools are often designed to enable the creation of campaign in an ad hoc, channel-by-channel manner. The example campaign management GUI depicted in FIGS. 11-13 is instead designed to ease a planner's burden in creating omni-channel campaigns. The disclosed GUI also enables campaigns to take advantage of the predictive contextual insights described elsewhere herein. For example, contextual data can facilitate efficiency gains when planning an advertisement action by organizing inter-related campaigns under the same advertisement program and the integration of contextual insights and micro-segments that dynamically matches when, what, where and who that a planner intend to run its campaigns.

FIGS. 11-13 are screenshots of a GUI 1100 for illustrating how an omni-channel campaign can be efficiently set up with dynamic contextual variables as part of the campaign metadata 380 as can be implemented in some embodiments. The program and campaign taxonomy can map the traditional retail organization's marketing calendar well.

The planning GUI of FIGS. 11-13 may be organized based on various levels of campaign analysis. For example, a campaign planner may organize their campaign as a plurality of “programs”, e.g., to raise awareness for a product or to increase conversions. Each program can include a collection of campaigns used to carry out the execution of tactics defined by such program. A program makes it easy for a planner to manage marketing by setting strategy at the most strategic level and letting the Contextual Advertising System 205 then execute rules on all campaigns in that program. Thus, programs can serve as “smart folders” which provide the option (but not the obligation in some embodiments) to apply business rules (strategy) to all the campaigns contained within the program. The campaigns can each inherit the rules applicable to their program.

As an example, following a segmentation analysis the system can determine that Population A will likely purchase Product A on a given date. A planner, implementing an initiative to increase sales of a category of products, can direct the system to prepare a program having campaigns advertising and selling Product B. The system, recognizing that Product A will better serve the purposes of the program, can propose that the planner substitute Product A for Product B instead. This recognition can be possible because the planner specified the relevant rules when creating the program and/or campaign.

FIG. 11 is a GUI for an example campaign planning tool. In this example, the tool defines a program “Outdoor Living” 1120. The planning view can provide a strategic, time-based management view of the marketing planning function including visibility into how programs and campaigns are performing over time. The view can also indicate the brands and products participating in the marketing programs. The calendar 1110 is visually managed and populated with campaigns 1110. The tool can provide a graphical view to plan, assess status, and drill into programs, campaigns, budgets, participating products, etc.

A summary row 1105 can depict the program's advertisement duration, budget available to the planner and the number of desired impressions. The calendar 1110 in a timeline row can indicate various omni-channel “campaigns” (here “camping and fishing” 1120a, “clean up time” 1120b, “water activities” 1120c, “cycling” 1120d, etc.) under the “Outdoor Living” program. The omni-channel campaigns can reflect time periods over which a portion of the advertisement campaign is to operate on various channels.

A 4-panel view 1115 depicts a way for program's strategy to be described by Products 1105a, Channels 1105b, Dynamics 1105c, and Audience 1105d) so these program rules can be inherited down to any campaign in that program. For example, here, one or more of cleaning products and snack foods could be presented in the “clean up time”, “water activities”, and “cycling segments”, but not in the “camping and fishing” segment. Similarly, weather and inventory business rules could be considered in all the segments except the “clean up time” segment. Selecting each of the columns in row 1115 can present a set of common products, channels, dynamics, and audience for the “Outdoor Living” program.

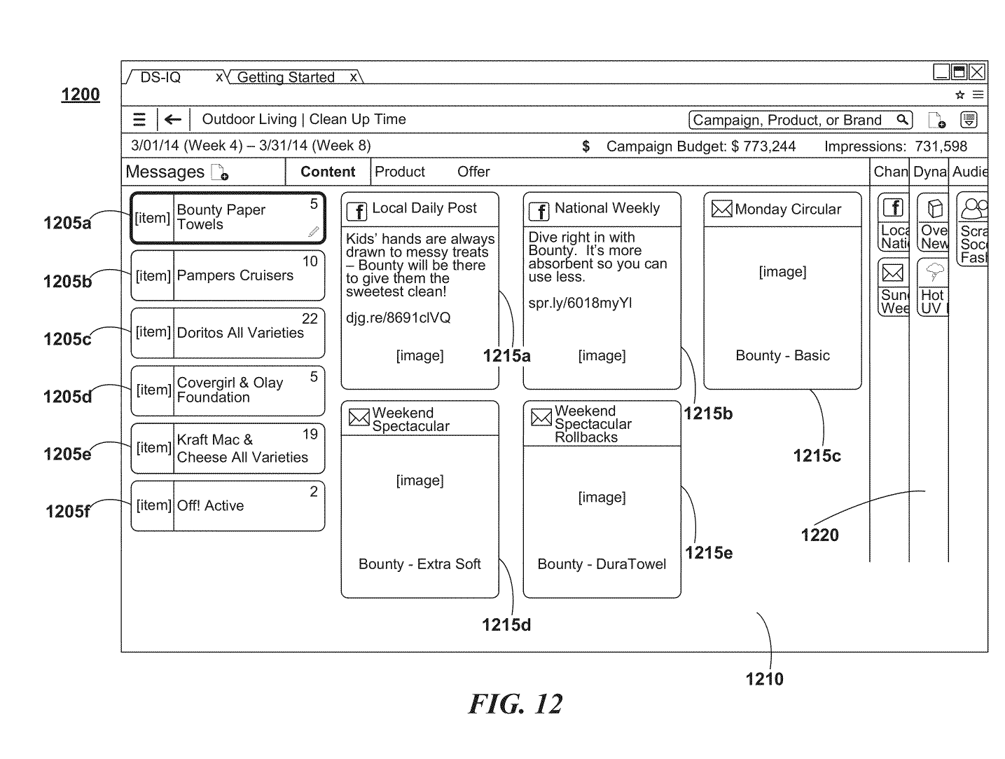

FIG. 12 is a screenshot of a GUI representing the planning view of an omni-channel campaign “Cleanup Time” 1120b that belongs to the “Outdoor Living” program. Here, the “Cleanup Time” campaign 1120b planning has inherited some Channel, Dynamics and Audience settings previously specified at the program level, but allows product messages to be created for targeted channels as can be implemented in some embodiments. A plurality of messages 1205a, 1205b, 1205c, 1205d, 1205e, and 1205f can be created by the user or the system and labelled in a left-most column. Each message allows a planner to assemble assets (e.g., text, images, video) and optionally associate products, an offer, or scan code into a unit that can be presented to a shopper. A message can be customized and displayed in different channels as illustrated in channels 1215a-e with each channel represented by a preview template highlighting channel associated product text and images in region 1210.

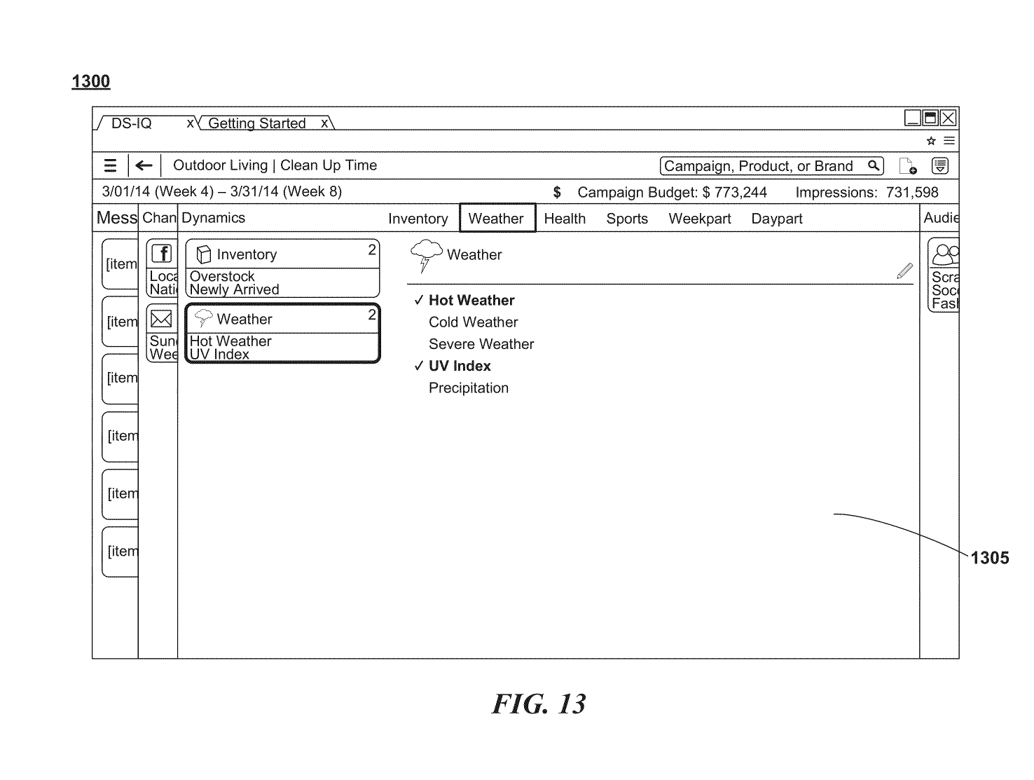

FIG. 13 is a screenshot of a GUI 1300 for adding contextual variables to a campaign construction analysis as can be implemented in some embodiments. Here, weather variables (“Hot Weather”, “Cold Weather”, Severe Weather”, “UV Index”, “Precipitation”) are presented in region 1305, though Inventory, Health, Sports, Weekpart, Daypart and other pertinent contextual variables can be provided. The user may have reached this interface by selecting the “Dynamics” tab 1220 from the GUI of FIG. 12. In this example, the user has selected the two contextual Inventory related variables “Inventory Over Stock”, “Newly Arrived” and two Weather related variables “Hot Weather” and “UV Index”.

### Computer System

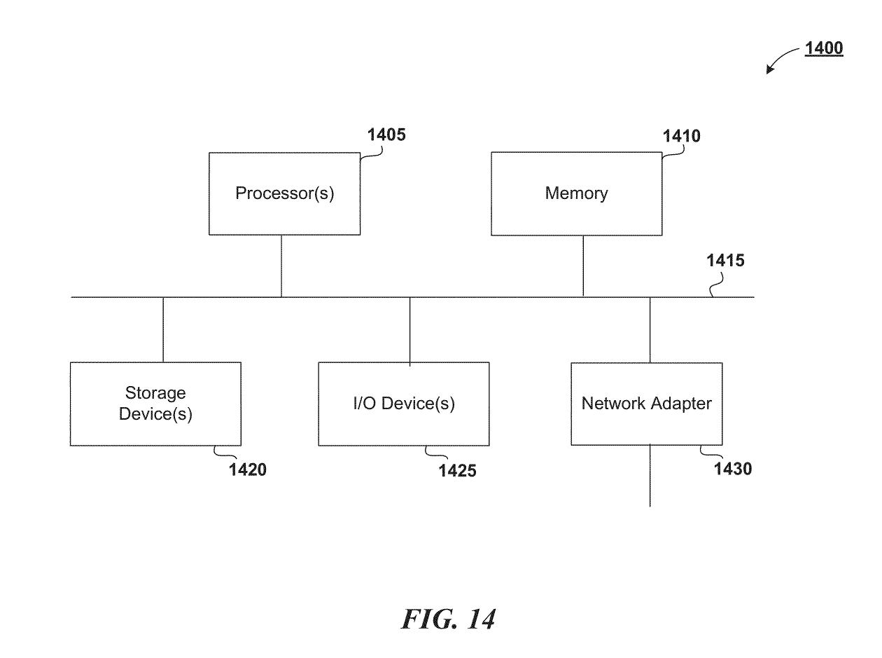

FIG. 14 is a block diagram of a computer system as may be used to implement features of some of the embodiments. The computing system 1400 may include one or more central processing units (“processors”) 1405, memory 1410, input/output devices 1425 (e.g., keyboard and pointing devices, display devices), storage devices 1420 (e.g., disk drives), and network adapters 1430 (e.g., network interfaces) that are connected to an interconnect 1415. The interconnect 1415 is illustrated as an abstraction that represents any one or more separate physical buses, point to point connections, or both connected by appropriate bridges, adapters, or controllers. The interconnect 1415, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The memory 1410 and storage devices 1420 are computer-readable storage media that may store instructions that implement at least portions of the various embodiments. In addition, the data structures and message structures may be stored or transmitted via a data transmission medium, e.g., a signal on a communications link. Various communications links may be used, e.g., the Internet, a local area network, a wide area network, or a point-to-point dial-up connection. Thus, computer readable media can include computer-readable storage media (e.g., “non transitory” media) and computer-readable transmission media.

The instructions stored in memory 1410 can be implemented as software and/or firmware to program the processor(s) 1405 to carry out actions described above. In some embodiments, such software or firmware may be initially provided to the processing system 1400 by downloading it from a remote system through the computing system 1400 (e.g., via network adapter 1430).

The various embodiments introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

### REMARKS

The above description and drawings are illustrative and are not to be construed as limiting. Numerous specific details are described to provide a thorough understanding of the disclosure. However, in certain instances, well-known details are not described in order to avoid obscuring the description. Further, various modifications may be made without deviating from the scope of the embodiments. Accordingly, the embodiments are not limited except as by the appended claims.

While the flow and sequence diagrams presented herein show an organization designed to make them more comprehensible by a human reader, those skilled in the art will appreciate that actual data structures used to store this information may differ from what is shown, in that they, for example, may be organized in a different manner; may contain more or less information than shown; may be compressed and/or encrypted; etc.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given above. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

1. A computer-implemented method for generating segmented population data clusters comprising:
receiving, at a computing system, from a plurality of retail organizations and third party sources, customer data and contextual data;
constructing, by the computing system, a dataset based on the received customer data and contextual data, the dataset including timestamp and location information;
cleaning the dataset to resolve ambiguities in the dataset;
applying, by the computing system, a dimension reduction algorithm to the dataset to determine a plurality of most-significant dimensions of the dataset;
grouping, by the computing system, customers from the dataset based upon the plurality of most-significant dimensions into a plurality of segments, the plurality of segments corresponding to a total ordering;
identifying, by the computing system, two or more segments from the plurality of segments based upon a plurality of advertisement campaign conditions, wherein the identified segments rank higher in the total ordering than other segments of the total ordering and collectively achieve a desired audience campaign targeting size; and
using, by the computing system, the identified two or more segments to cause an advertising campaign to be implemented having the desired audience campaign targeting size.

2. The computer-implemented method of claim 1, wherein the dimension reduction algorithm comprises a Principal Component Analysis.

3. The computer-implemented method of claim 1, wherein the contextual data comprises weather data.

4. The computer-implemented method of claim 1, wherein the dataset comprises consolidated “Place”, “Person”, and “Product” asset data.

5. The computer-implemented method of claim 1, wherein customers are represented by zip codes in the dataset.

6. The computer-implemented method of claim 1, the method further comprising applying a power transform to the dataset.

7. The computer-implemented method of claim 6, wherein the power transform is a Box-Cox transform.

8. A non-transitory computer-readable medium comprising instructions configured to cause one or more processor to perform a method comprising:
receiving, at a computing system, from a plurality of retail organizations and third party sources, customer data and contextual data;
constructing, by the computing system, a dataset based on the received customer data and contextual data, the dataset including timestamp and location information;
applying, by the computing system, a dimension reduction algorithm to the dataset to determine a plurality of most-significant dimensions of the dataset;
grouping, by the computing system, customers from the dataset based upon the plurality of most-significant dimensions into a plurality of segments, the plurality of segments corresponding to an ordering;
identifying, by the computing system, two or more segments from the plurality of segments based upon a plurality of advertisement campaign conditions, wherein the identified segments rank higher in the ordering than other segments of the ordering and collectively achieve a desired audience campaign targeting size; and
using, by the computing system, the identified two or more segments to cause an advertising campaign to be implemented having the desired audience campaign targeting size.

9. The non-transitory computer-readable medium of claim 8, wherein the dimension reduction algorithm comprises a Principal Component Analysis.

10. The non-transitory computer-readable medium of claim 8, wherein the contextual data comprises weather data.

11. The non-transitory computer-readable medium of claim 8, wherein the dataset comprises consolidated “Place”, “Person”, and “Product” asset data.

12. The non-transitory computer-readable medium of claim 8, wherein customers are represented by zip codes in the dataset.

13. The non-transitory computer-readable medium of claim 8, the method further comprising applying a power transform to the dataset.

14. The non-transitory computer-readable medium of claim 13, wherein the power transform is a Box-Cox transform.

15. A computer system comprising:
at least one processor;
at least one memory comprising instructions configured to cause the at least one processor to perform a method comprising:
receiving, at the computer system, from a plurality of retail organizations and third party sources, customer data and contextual data;
constructing, by the computing system, a dataset based on the received customer data and contextual data, the dataset including timestamp and location information;
applying, by the computing system, a dimension reduction algorithm to the dataset to determine a plurality of most-significant dimensions of the dataset;
grouping, by the computing system, customers from the dataset based upon the plurality of most-significant dimensions into a plurality of segments, the plurality of segments corresponding to an ordering;
identifying, by the computing system, two or more segments from the plurality of segments based upon a plurality of advertisement campaign conditions, wherein the identified segments rank higher in the ordering than other segments of the ordering and collectively achieve a desired audience campaign targeting size; and
using, by the computing system, the identified two or more segments to cause an advertising campaign to be implemented having the desired audience and campaign targeting size.

16. The computer system of claim 15, wherein the dimension reduction algorithm comprises a Principal Component Analysis.

17. The computer system of claim 15, wherein the dataset comprises consolidated “Place”, “Person”, and “Product” asset data.

18. The computer system of claim 15, wherein customers are represented by zip codes in the dataset.

19. The computer system of claim 15, the method further comprising applying a power transform to the dataset.

20. The computer system of claim 19, wherein the power transform is a Box-Cox transform.
